(19) United States
(12) Patent Application Publication
(10) Pub. No.: US 2010/0164881 A1
(43) Pub. Date: Jul. 1, 2010

(54) Touch Panel Structure

(75) Inventors: Han-Ping Kuo, Hsinchu (TW); Martinus Tony Wijaya, Hsinchu (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: AU OPTRONICS CORP., Hsinchu (TW)

(21) Appl. No.: 12/467,577

(22) Filed: May 18, 2009

(30) Foreign Application Priority Data
Dec. 25, 2008 (TW) 97150673

(51) Int. Cl. G06F 3/041

(52) U.S. Cl. 345/173

(57) ABSTRACT

A touch panel structure is provided. The touch panel structure comprises a cover glass, a first transparent electrode and a light shielding element. The cover glass has a touch surface, a sensing surface corresponding to the touch surface, wherein the sensing surface is defined with a center area and a peripheral area surrounding the center area thereon. The first transparent electrode is formed on the cover glass, comes into contact with the sensing surface and is disposed in the center area correspondingly. The light shielding element is formed on the cover glass, comes into contact with the sensing surface and is disposed in the peripheral area correspondingly.

This application claims priority to Taiwan Patent Application No. 097150673 filed on Dec. 25, 2008, the content of which is incorporated herein by reference in its entirety.

### CROSS-REFERENCES TO RELATED APPLICATIONS

Not applicable.

### BACKGROUND OF THE INVENTION

1. Field of the Invention

The present invention relates to a thin type display, and more particularly, to a touch panel structure for use in a thin type display.

2. Descriptions of the Related Art

With the rapid development of portable electronic apparatuses, displays using the traditional key-pressing input mode have been gradually replaced by those with a touch function. Typically, in this kind of conventional touch panel, a glass substrate with a touch sensing function is additionally disposed underneath a cover glass or a cover lens of the display panel to convert an external touch signal into an input signal.

FIG. 1 is a schematic view of a conventional touch panel structure 1. The touch panel structure 1 primarily comprises of a cover glass 10 or a cover lens, a touch glass substrate 11 and a liquid crystal display (LCD) panel. The LCD panel primarily comprises a color filter substrate 15, an active-element array substrate 16, a top polarizing layer 17 and a bottom polarizing layer 18. The cover glass 10 is attached to the touch glass substrate 11 and the LCD panel with an adhesion layer 14 to protect the touch glass substrate 11 and the LCD panel. Additionally, for aesthetic purposes, the touch panel structure 1 may further has a decorative coating layer 12 which is attached onto the cover glass 10 via another adhesion layer 13.

In this touch panel structure, the touch glass substrate 11 is disposed underneath the cover glass and shielded by the cover glass 10, the decorative coating layer 12, the adhesion layer 13, the adhesion layer 14 and the top polarizing layer 17, so it has low touch sensing sensitivity.

More specifically, in reference to FIG. 2, when a user touches the surface of the touch panel structure 1 with his or her finger, the sensitivity (S) between the user's finger and the touch glass substrate 11 may be indicated by an equivalent capacitance Cₜₒₜₐₗ. In particular, the sensitivity (S) is directly proportional to Cₜₒₜₐₗ; i.e., the larger the equivalent capacitance Cₜₒₜₐₗ, the better the sensitivity (S). Such an equivalent capacitance Cₜₒₜₐₗ is correlated with the capacitance of the individual layers in the touch glass substrate 11, i.e., correlated with the capacitance of the cover glass 10, the decorative coating layer 12, the adhesion layer 13, the adhesion layer 14 and the top polarizing layer 17, which are in series and may be represented by the following equation:

$$\frac{1}{S} ∝ \frac{1}{{C}_{total}} = \frac{1}{{C}_{12}} + \frac{1}{{C}_{13}} + \frac{1}{{C}_{10}} + \frac{1}{{C}_{14}} + \frac{1}{{C}_{17}} \qquad ( 1 )$$

where C₁₂, C₁₃, C₁₀, C₁₄, C₁₇ represents the capacitance of the decorative coating layer 12, the adhesion layer 13, the cover glass 10, the adhesion layer 14 and the top polarizing layer 17 respectively. From Equation (1), the following Equation (2) may be further derived:

$$\frac{1}{S} ∝ \frac{A}{{C}_{total}} = \frac{1}{\frac{{ɛ}_{12}}{{d}_{12}}} + \frac{1}{\frac{{ɛ}_{13}}{{d}_{13}}} + \frac{1}{\frac{{ɛ}_{10}}{{d}_{10}}} + \frac{1}{\frac{{ɛ}_{14}}{{d}_{14}}} + \frac{1}{\frac{{ɛ}_{17}}{{d}_{17}}} \qquad ( 2 )$$

where A represents an area where the user's finger contacts the touch panel structure 1, and ε₁₂, ε₁₃, ε₁₀, ε₁₄, ε₁₇ and d₁₂, d₁₃, d₁₀, d₁₄, d₁₇ represent dielectric constants and thicknesses of the decorative coating layer 12, the adhesion layer 13, the cover glass 10, the adhesion layer 14 and the top polarizing layer 17 respectively. It can be seen from Equation (2) that if the sensing sensitivity of the touch panel structure 1 needs to be enhanced by increasing the equivalent capacitance Cₜₒₜₐₗ, the sum of the items at the right side of the equity sign in Equation (2) must be decreased. However, if the structure of the touch panel structure 1 remains unchanged, even the improvement on the materials (i.e., increasing the dielectric constant) and the decrease in thickness of the decorative coating layer 12, the adhesion layer 13, the cover glass 10, the adhesion layer 14 and the top polarizing layer 17 would only increase the equivalent capacitance Cₜₒₜₐₗ by a limited amount.

Furthermore, the touch panel structure 1 uses a lot of glass substrates which have a considerable thickness and weight. Hence, when the touch panel structure 1 is applied on a small-sized panel product, it will be very difficult to obtain a lightweight and thin type product and also increase production costs.

In view of this, it is important to provide a touch panel structure with high touch sensitivity and that is also lightweight and has a low profile.

### SUMMARY OF THE INVENTION

One objective of this invention is to provide a touch panel structure with a light weight, thin type structure and high touch sensing sensitivity and reliability.

This invention provides a touch panel structure. The touch panel structure comprises a cover glass or a cover lens, a first transparent electrode and a light shielding element. The cover glass has a touch surface and a sensing surface corresponding to the touch surface, wherein the sensing surface has a center area and a peripheral area surrounding the center area defined thereon. The first transparent electrode, which is disposed on the cover glass, comes into the contact with the sensing surface and is disposed correspondingly inside the center area. The light shielding element, which is disposed on the cover glass, comes into contact with the sensing surface and is disposed correspondingly inside the peripheral area.

With this arrangement, the cover glass for protecting the surface of the touch panel can have the conventional decorative coating layer integrated thereon to provide an aesthetic appearance for the product. Meanwhile, this arrangement also decreases the thickness and weight of the product and improves the touch sensitivity.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view of a conventional touch panel structure;

FIG. 2 is a schematic view of an equivalent capacitance of a conventional touch panel structure;

FIG. 3a is a schematic view of a touch panel structure in the first embodiment of this invention;

FIG. 3b is a schematic view of a touch panel structure in the second embodiment of this invention;

FIG. 4 is a schematic view of a touch panel structure in the third embodiment of this invention;

FIG. 5a is a schematic view of a touch panel structure in the fourth embodiment of this invention;

FIG. 5b is a schematic view of a touch panel structure in the fifth embodiment of this invention; and

FIG. 5c is a schematic view of a touch panel structure in the sixth embodiment of this invention.

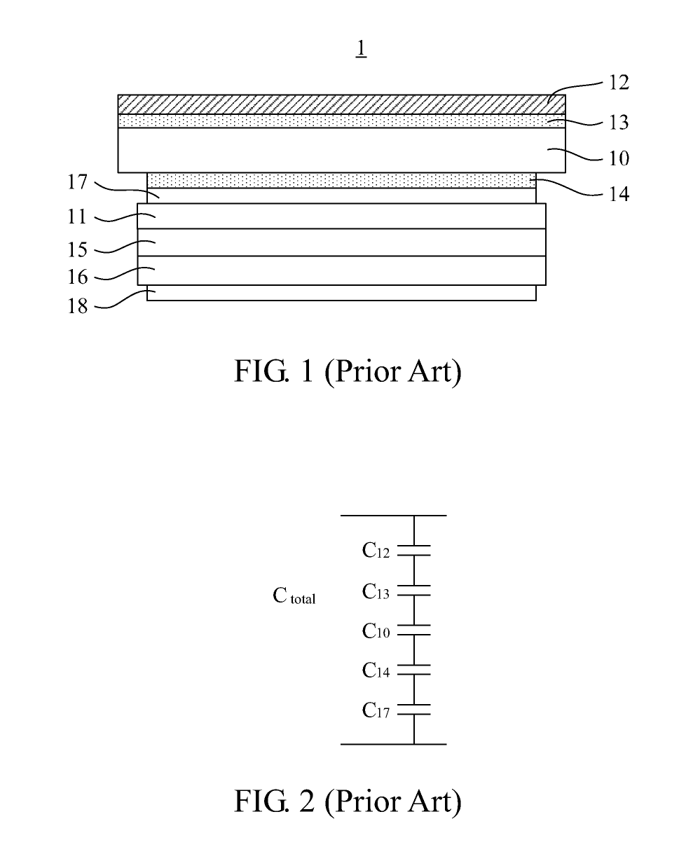

### DESCRIPTION OF THE PREFERRED EMBODIMENT

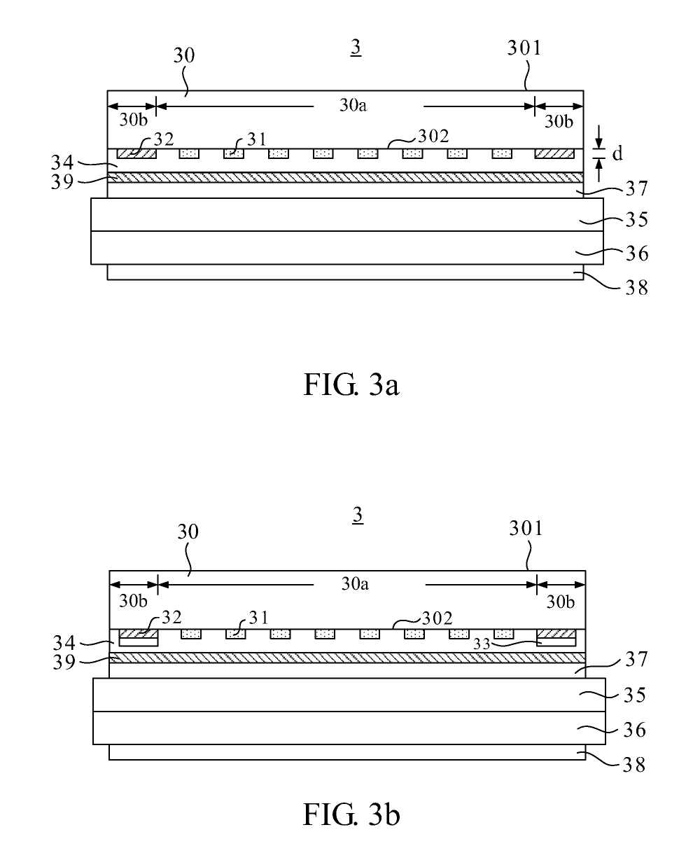

In reference to FIG. 3a, a schematic view of a touch panel structure 3 according to the first embodiment of this invention is depicted therein. The touch panel structure 3 comprises a cover glass 30 and a touch sensing layer. In this embodiment, the touch sensing layer comprises a first transparent electrode 31, a light shielding element 32 and an adhesive protecting layer 34. The cover glass 30 has a touch surface 301 and a sensing surface 302 on two sides thereof respectively. The touch surface 301 is disposed on the outermost side of the display device for the user to touch directly. The sensing surface 302 is an inner surface opposite the touch surface 301. Additionally, in terms of the touch or display function, the sensing surface 302 of the cover glass 30 may further have a center area 30a and a peripheral area 30b defined thereon. The center area 30a corresponds to the display area of the touch panel, while the peripheral area 30b corresponds to the non-display area of the touch panel and is disposed so that it surrounds the center area 30a at the outer periphery of the sensing surface 302.

The first transparent electrode 31 is disposed on and makes direct contact with the sensing surface 302 of the cover glass 30, and is disposed correspondingly inside the center area 30a to function as a touch sensing electrode of the touch panel structure 3. The thickness of the first transparent electrode 31 may range between 1 micrometer (μm) and 2 μm. In application, the first transparent electrode 31 is made of indium tin oxide (ITO) or indium zinc oxide (IZO), although this invention is not merely limited thereto.

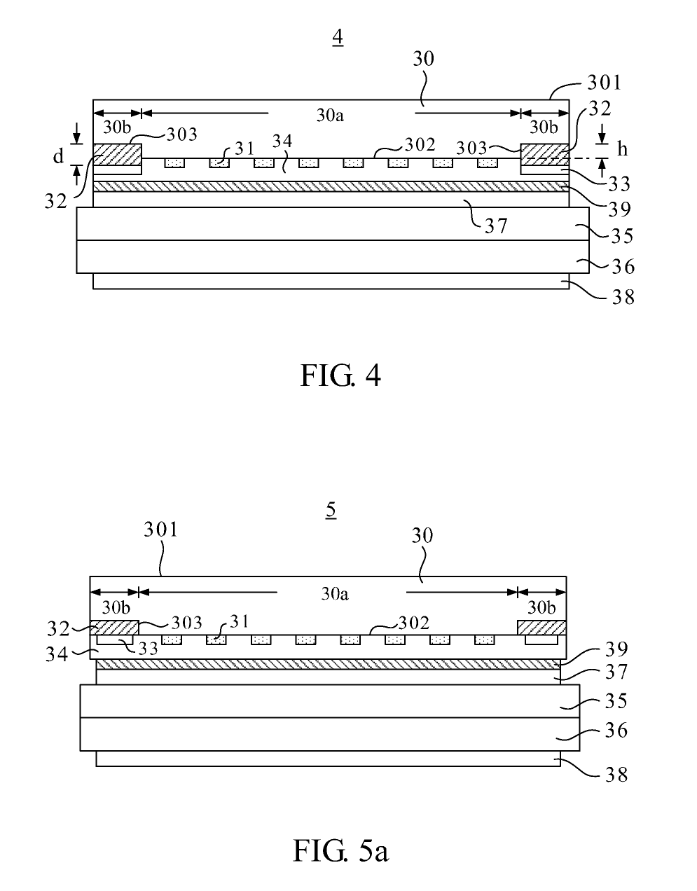

The light shielding element 32 is disposed on and makes direct contact with the sensing surface 302 of the cover glass 30, and is disposed correspondingly inside the peripheral area 30a. The light shielding element 32 allows the manufacturers to design different decorative patterns in the peripheral area 30b to decorate the general appearance of the product, and also shields the light leakage at the edge of the display device. Additionally, the light shielding element 32 has a thickness d, which may range between 1 μm and 2 μm. The light shielding element 32 may be disposed at any position inside the peripheral area 30b. In this embodiment, the lateral sides of the light shielding element 32 are not aligned with any lateral sides of the cover glass. However, in other embodiments, the lateral sides of the light shielding element 32 may be aligned with the lateral sides of the cover glass, as shown in FIG. 4. Furthermore, the light shielding element 32 may be made of high-temperature endurable ceramic pigment, which may be formulated into different colors depending on the practical needs, such as white pigment, red pigment, green pigment, blue pigment, black pigment and a combination thereof. The light shielding element 32 has a heat-resistant temperature between 200° C. and 800° C. to endure the high processing temperature during the post-processes of the cover glass 30. The touch panel structure 3 further has an adhesive protecting layer 34 disposed on the side of the sensing surface 302 to cover and protect the first transparent electrode 31 and the light shielding element 32.

Furthermore, in addition to the cover glass 30 and the touch sensing layer, the touch panel structure 3 also comprises a color filter substrate 35, an active-element array substrate 36, a top polarizing layer 37, a bottom polarizing layer 38 and an adhesion layer 39. The color filter substrate 35 and the active-element array substrate 36 are disposed between the top polarizing layer 37 and the bottom polarizing layer 38, while the adhesion layer 39 is adapted to attach the top polarizing layer 37 to the adhesive protecting layer 34 of the touch sensing layer. The color filter substrate 35, the active-element array substrate 36, the top and the bottom polarizing layers 37, 38 and the adhesion layer 39 are all conventional structures, and thus will not be further described herein.

According to the aforesaid theory for sensitivity calculation, the touch sensitivity of the touch panel structure 3 of this embodiment is only correlated with the cover glass on the touch sensing layer, and the equivalent capacitance Cₜₒₜₐₗ may be represented as the following equation:

$$\frac{1}{S} ∝ \frac{1}{{C}_{total}} = \frac{1}{{C}_{30}} \qquad ( 3 )$$

where C₃₀ represents the capacitance of the cover glass 30. Through observation of the above Equation (3), it can be known that the equivalent capacitance Cₜₒₜₐₗ will not be influenced by other components, which would otherwise decrease the amount of Cₜₒₜₐₗ consequently; thus, the sensing sensitivity (S) of the touch panel structure 3 can be improved effectively. Therefore, in addition to the function of protecting the touch panel structure 3, the cover glass 30 of this embodiment is also capable of decorating the product's appearance and improving the touch sensing sensitivity. Applying this touch panel structure 3 to the display device will help to decrease the thickness and weight of the product and lower the production cost.

FIG. 3b depicts a touch panel structure 3 according to the second embodiment of this invention. The touch panel structure 3 of this embodiment further comprises a second transparent electrode 33 which may be used for the circuit layout at the periphery of the touch panel. The second transparent electrode 33 is disposed on the cover glass at the side of the sensing surface 302 and is located inside the peripheral area 30b. Furthermore, the second transparent electrode 33 comes into contact with the light shielding element 32 to sandwich the light shielding element 32 between the cover glass 30 and the second transparent electrode 33. In this embodiment, the second transparent electrode 33 covers the surface of the light shielding element 32 completely, although this invention is not limited thereto; i.e., the second transparent electrode 33 may also partially cover the surface of the light shielding element 32.

Similar to the first transparent electrode 31, the second transparent electrode 33 may be made of ITO or IZO, although this invention is not limited thereto. For convenience of production, the second transparent electrode 33 may be made of the same material and in the same manufacturing process as the first transparent electrode 31; however, they may also be made of different materials in the same or different manufacturing processes, and this invention is not limited thereto. In this embodiment, the thickness of the second transparent electrode 33 may range between 1 μm and 2 μm.

FIG. 4 depicts a touch panel structure 4 according to the third embodiment of this invention. The touch panel structure 4 of this embodiment further comprises a groove 303. The groove 303 is disposed on the cover glass 30 at the side of the sensing surface 302 and located inside the peripheral area 30b; i.e., the sensing surface 302 is a surface with concave features. The groove 303 has a depth h ranging between 5 μm and 15 μm, and has a cross-section which may be a triangle, a right triangle, a square or a rectangle. The groove may be a closed groove entirely located inside the peripheral area 30b, or an open groove partially communicates with the outside and partially located inside the peripheral area 30b. The aforesaid materials of which the light shielding element 32 is made (e.g., the high-temperature endurable ceramic pigment) fills in at least the groove 303 and has a thickness d ranging between 6 μm and 17 μm.

In this embodiment, the adhesive protecting layer 34 is disposed on the cover glass 30 and comes into contact with the sensing surface 302, the surface of the first transparent electrode 31, one of the surfaces of the light shielding element 32 and the surface of the second transparent electrode 33. The surface of the first transparent electrode 31, the surface of the light shielding element 32 and the surface of the second transparent electrode 33 refer to the surfaces parallel to or lateral to the sensing surface 302, although this invention is not limited thereto. In this embodiment, the groove 303 is a rectangular open groove so that the lateral sides of the light shielding element 32 are aligned with the lateral sides of the cover glass 30, while the second transparent electrode 33 may also be aligned with the lateral sides of the cover glass 30, although this invention is not limited thereto.

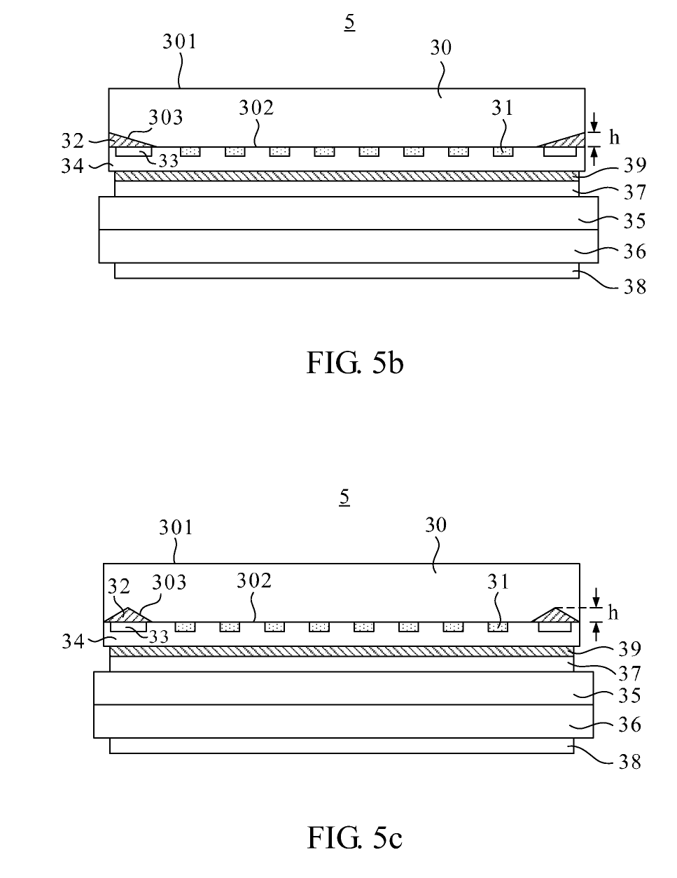

FIG. 5a depicts a touch panel structure according to the fourth embodiment of this invention. In this embodiment, the light shielding element 32 filled into the groove 303 of the cover glass 30 fills up or at least fills in the groove 303 on the sensing surface 302. The second transparent electrode 33 may partially cover the surface of the light shielding element 32 (i.e., at least cover a portion of the light shielding element 32), and may have a thickness ranging between 1 μm and 2 μm. Furthermore, the lateral sides of the light shielding element 32 are aligned with the lateral sides of the cover glass 30, while the second transparent electrode 33 is not aligned with the lateral sides of the cover glass 30 and may protrude from the lateral sides of the cover glass 30 or be located at the inner sides of the two end edges of the cover glass 30, although this invention is not limited thereto.

FIG. 5b depicts a touch panel structure according to the fifth embodiment of this invention. In this embodiment, the groove 303 of the cover glass 30 is a right-triangle shaped open groove and has a depth h that corresponds to the maximum depth of the groove 303. In this embodiment, the light shielding element 32 at least fills up the groove 303. Herein, “at least fills up” means that the surface of the light shielding element 32 is level to, protrudes from or is slightly recessed from the groove 303, which may be attributed to the design requirements or the manufacturing process variations, although this invention is not limited thereto. The second transparent electrode 33 partially covers the light shielding element 32.

FIG. 5c depicts a touch panel structure according to the sixth embodiment of this invention. In this embodiment, the groove 303 of the cover glass 30 is a triangle shaped closed groove and has a depth h that corresponds to the maximum depth of the groove 303.

According to the above descriptions, by disposing both the light shielding element and the transparent electrode on the cover glass, the cover glass is provided with both functions of making the product appearance aesthetic and sensing touches. This eliminates the shortcoming of a thick-profile, a heavy product weight and a decrease in the touch sensitivity by using multiple glass substrates in a conventional touch panel structure, and further lowers the production cost and enhances the competitiveness of the product.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A touch panel structure, comprising:
a cover glass, having a touch surface and a sensing surface corresponding to the touch surface, the sensing surface having a center area and a peripheral area surrounding the center area defined thereon;
a first transparent electrode, disposed on the cover glass, contacting the sensing surface and disposed correspondingly inside the center area; and
a light shielding element, disposed on the cover glass, contacting the sensing surface and disposed correspondingly inside the peripheral area.

2. The touch panel structure as claimed in claim 1, wherein the first transparent electrode has a thickness between 1 micrometer and 2 micrometers.

3. The touch panel structure as claimed in claim 1, wherein the light shielding element has a thickness between 1 micrometer and 2 micrometers.

4. The touch panel structure as claimed in claim 1, wherein at least one side of the light shielding element is aligned with a side of the cover glass.

5. The touch panel structure as claimed in claim 1, wherein the sensing surface further has a groove, and the light shielding element at least fills up the groove.

6. The touch panel structure as claimed in claim 5, wherein the groove has a depth between 5 micrometers and 15 micrometers.

7. The touch panel structure as claimed in claim 5, wherein the light shielding element has a thickness between 6 micrometers and 17 micrometers.

8. The touch panel structure as claimed in claim 1, wherein a material of the light shielding element is made of high-temperature endurable ceramic pigment.

9. The touch panel structure as claimed in claim 1, wherein the light shielding element has a heat-resistant temperature between 200° C. and 800° C.

10. The touch panel structure as claimed in claim 1, further comprising a second transparent electrode, disposed on the cover glass and correspondingly to the peripheral area.

11. The touch panel structure as claimed in claim 10, wherein the second transparent electrode has a thickness between 1 micrometer and 2 micrometers.

12. The touch panel structure as claimed in claim 10, wherein the second transparent electrode at least covers one part of the light shielding element.

13. The touch panel structure as claimed in claim 10, wherein the second transparent electrode contacts a surface of the light shielding element.

14. The touch panel structure as claimed in claim 10, wherein the light shielding element is disposed between the cover glass and the second transparent electrode.

15. The touch panel structure as claimed in claim 10, wherein at least one side of the light shielding element is aligned with a side of the second transparent electrode.

16. The touch panel structure as claimed in claim 10, further comprising an adhesive protecting layer, disposed on the cover glass and contacting the sensing surface, the surface of the first transparent electrode and one of the surface of the light shielding element and the surface of the second transparent electrode.

17. The touch panel structure as claimed in claim 16, further comprising a color filter substrate and an active-element array substrate both disposed correspondingly to the adhesive protecting layer.

18. The touch panel structure as claimed in claim 17, further comprising a top polarizing layer, disposed between the adhesive protecting layer and the color filter substrate.

19. The touch panel structure as claimed in claim 18, further comprising an adhesion layer, disposed between the adhesive protecting layer and the top polarizing layer.

20. The touch panel structure as claimed in claim 17, further comprising a bottom polarizing layer, disposed on the surface of the active-element array substrate.
